(19) United States
(12) Patent Application Publication
(10) Pub. No.: US 2009/0273908 A1
(43) Pub. Date: Nov. 5, 2009

(54) NETWORK TRANSFORMER, NETWORK MODULE THEREOF, AND ELECTRONIC DEVICE THEREOF

(75) Inventors: Wei-Chun Tsao, Taipei (TW); Chien-Ru Lin, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: UNIHAN CORPORATION, Taipei City (TW)

(21) Appl. No.: 12/407,589

(22) Filed: Mar. 19, 2009

(30) Foreign Application Priority Data
Apr. 30, 2008 (TW) 097115818

(51) Int. Cl. H05K 7/00; H01F 27/02

(52) U.S. Cl. 361/748; 336/90

(57) ABSTRACT

The invention discloses a network transformer, a network module thereof, and an electronic device thereof The network transformer includes a plurality of coil sets, an insulating board, a casing and a plurality of pins. The pins are disposed on the casing. The network transformer is disposed on a PCB via the pins. The insulating board is disposed in the casing and connects with at least two side walls of the casing to form a plurality of isolation chambers, each of which is for containing one coil set.

### BACKGROUND OF THE INVENTION

1. Field of the Invention

The invention relates to a transformer and, more particularly, to a network transformer.

2. Description of the Prior Art

With the development of the computer technology, the network technology is improving day by day. The current computer is gradually departing from the stand-alone operation and moving into the network operation era. Therefore, various network modules and devices for controlling network connections are also under development.

Generally speaking, various computer devices are connected with other computers in the network via network modules and network cables. FIG. 1A is a schematic diagram showing a typical computer device connecting to the network. A computer device 101 is connected to the Internet 103 via a network cable 104a. A computer device 102 is connected to the Internet 103 via a network cable 104b. Therefore, data or information can be transmitted between the computer device 101 and the computer device 102 via the Internet 103.

FIG. 1B is a schematic diagram showing a network module of the computer device. The network module 110 includes a network chip 111, a network transformer 112, and a network connector 113 for connecting a network cable 114.

The network transformer 112 is also called as a network insulating transformer, and is mainly for providing the impedance matching and abnormality isolation. For example, when the impedances of the computer devices (or the network devices) connected by the network cable are not equal, the impedances can be adjusted by changing the turns of coil sets in the network transformer 112 to match the impedances of the devices connected by the network cable.

The voltages of the devices connected by the network cable may not be the same. Under the protection of the network transformer, the damage caused by the connections of the devices of different voltages can be avoided. Moreover, the network transformer also can avoid the local computer device (or network device) being damaged by the transient voltage transmitted from the network cable.

FIG. 2 is a schematic diagram of a conventional network transformer. The network transformer 20 includes a insulating casing 21, metal pins 22, and a plurality of coil sets 23 electrically connected with the metal pins 22. The coil sets 23 are disposed in parallel in the insulting casing 21, and the distances between the coil sets 23 are very close. The disadvantage of the conventional network transformer is that during the procedure of producing the network transformer 20, the enameled wire of the coil sets 23 may be damaged or have inherent defects. When the network module is struck by lightning, the transient voltage of the coil 23 may cause the insulation layer of the enameled wire to be broken through. This makes the coil 23 to couple to another coil and further causes the damage of the network device.

### SUMMARY OF THE INVENTION

The invention provides a network transformer to improve the current technique.

According to a specific embodiment, the invention provides a network transformer including a plurality of coil sets, a casing, an insulating board, and a plurality of pins. The insulating board is disposed in the casing and connects with at least two side walls of the casing to form a plurality of isolation chambers, so that each of chambers contains one coil set. The pins are provided on the casing. The network transformer is disposed on a PCB via the pins.

According to a specific embodiment, the invention provides an electronic device including a circuit board, a CPU, a chipset, a network chip, a network connector, and a network transformer. The CPU is disposed on the circuit board. The chipset is coupled with the CPU and disposed on the circuit board. The network connector is disposed on the circuit board. The network transformer is separately coupled with the network chip and the network connector. The network transformer further includes a plurality of coil sets, an insulating board, a plurality of pins, and a casing. The pins are disposed on the casing. The network transformer is disposed on a PCB via the pins. The insulating board is disposed in the casing and connects with at least two side walls of the casing to form a plurality of isolation chambers for separately containing the coil sets.

According to a specific embodiment, the invention provides a network module including a network chip, a network connector, and a network transformer. The network transformer is separately coupled with the network chip and the network connector. The network transformer includes a plurality of coil sets, an insulating board, a plurality of pins, and a casing. The pins are disposed on the casing. The network transformer is disposed on a PCB via the pins. The insulating board is disposed in the casing and connects with at least two side walls of the casing to form a plurality of isolation chambers for separately containing the coil sets.

The advantage of the invention is described hereinafter. The insulating board is disposed in the casing of the network transformer to form a plurality of isolation chambers for separating the coil sets, which avoids the coil set breakdown by lightning when the network transformer is struck by the transient voltage of lightning, and further to avoid the network device being damaged. The invention can improve the lightning protective effect of the network transformer and save the cost of using periphery devices, that achieves the cost advantage.

These and other features, aspects, and advantages of the present invention will become better understood with regard to the following description, appended claims, and accompanying drawings.

### BRIEF DESCRIPTION OF THE APPENDED DRAWINGS

FIG. 1A is a schematic diagram showing the typical computer device connecting to the network.

FIG. 1B is a schematic diagram showing the network module of the computer device in the prior art.

FIG. 2 is a schematic diagram of the conventional network transformer.

FIG. 3 is a schematic diagram showing the network transformer in the preferred embodiment of the invention.

FIG. 4 is a schematic diagram showing the network transformer filled with insulating adhesive in the embodiment of the invention.

FIG. 5 is a schematic diagram of the network transformer according to another embodiment of the invention.

FIG. 6 is a schematic diagram showing an embodiment that the network transformer is applied in an electronic device.

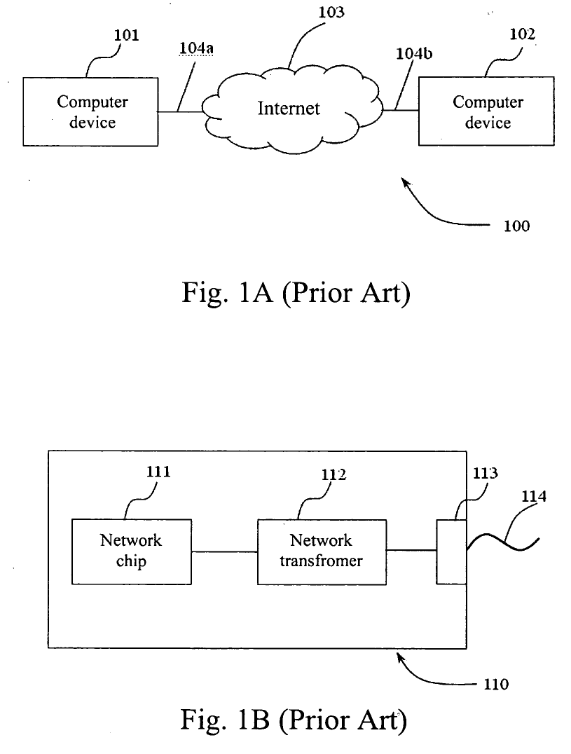

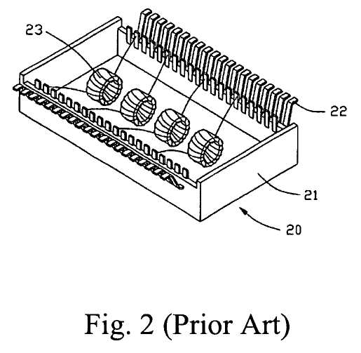

### DETAILED DESCRIPTION OF THE INVENTION

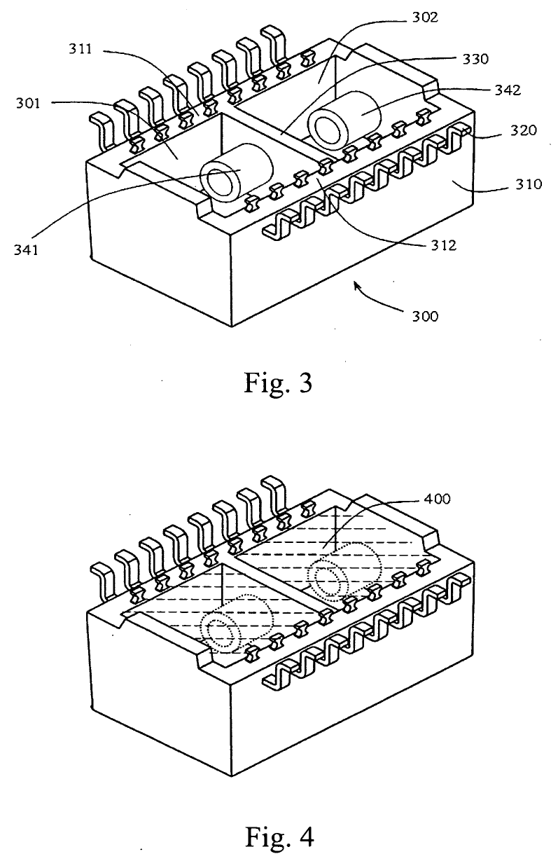

FIG. 3 is a schematic diagram showing the network transformer of the first embodiment of the invention. In the embodiment, the network transformer 300 is mostly disposed in the network card, which can be either an independent network card or a network module integrated on the motherboard. In other embodiments, the network transformer 300 also can be disposed on the motherboard of the computer along with the network chip and a network connector to form a network module. The network transformer 300 provided in the embodiment includes a plurality of coil sets 341 and 342, an insulating board 330, a plurality of pins 320, and a casing 310.

The pins 320 are disposed on the casing 310. The network transformer 300 is disposed on a printed circuit board via the pins 320 of the casing 310.

The insulating board 330 is disposed in the casing 310 and connected with side walls 311 and 312 of the casing 310 to separate the casing 310 into two isolation chambers 301 and 302. In the embodiment, the casing 310 and the insulating board 330 is integrally formed. In other embodiments, the casing 310 and the insulating board 330 can be two separated components, and the insulating board 330 is plugged in the casing 310. The insulating board 330 can be tightly disposed with the casing 310 via the adhesive or the wedge mechanism.

The isolation chamber 301 is for containing the coil set 341, and the isolation chamber 302 is for containing the coil set 344, so that each isolation chamber 301 or 302 can contain one coil set of the coil sets 341 and 342 to electrically insulate the coil sets 341 and 342.

Refer to FIG. 4. In the embodiment, each the isolation chamber 301 and 302 can be filled with insulating adhesive 400 to fix the coil sets 341 and 342 in the isolation chambers 301 and 302, which makes the coil sets 341 and 342 have better insulating effect.

In the embodiment, the material of the casing 310 and the insulating board 330 is flame-resistant diallyl phthalate molding material, which can ensure that the network transformer is not damaged in the high temperature caused by the transient voltage of lightning. In the embodiment, the cores of the coil sets 341 and 342 are toroidal cores, which can form a magnetic confining field with nearly perfect magnetic line of force. The magnetic line of force has small transmission distortion and its coupling factor can be close to 1. Furthermore, using the toroidal core causes advantage of small space usage and high efficient.

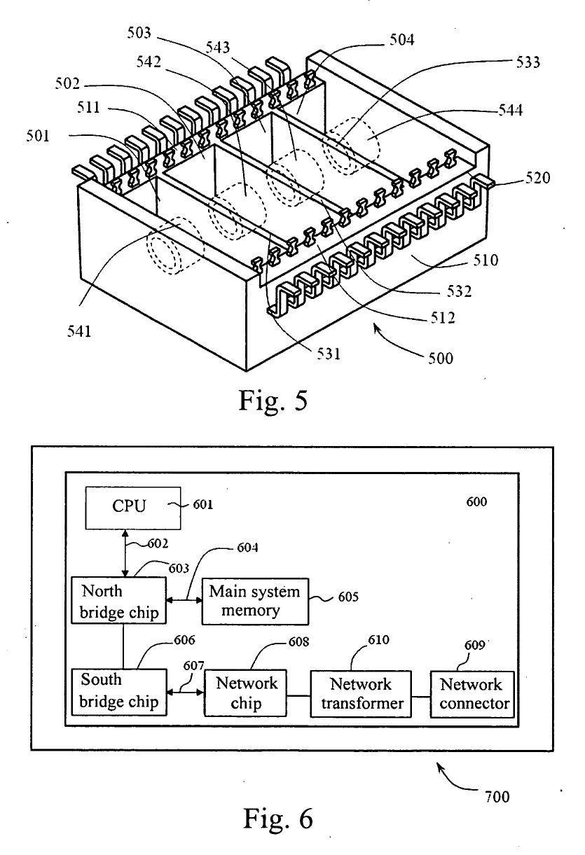

Refer to FIG. 5. FIG. 5 is a schematic diagram of the network transformer according to another embodiment of the invention. The network transformer 500 provided in the embodiment includes insulating boards 531, 532, 533, and side walls 511, 512 connected with a casing 510 to form four isolation chambers. The elements are similar to the corresponding elements in the embodiment described above and have the same functions, which will not be described here. The difference between the embodiment and the embodiment described above is that the network transformer 300 in the embodiment described above has two isolation chambers 301, 302 that can be applied in the 10/100M network module, and the network transformer 500 has four isolation chambers 501, 502, 503, and 504 that can be applied in the 1/10 G network module.

FIG. 6 is a schematic diagram showing an embodiment that the network transformer is applied in an electronic device. In the embodiment, the network transformer 610 is applied in the electronic device 700. The electronic device 700 includes a motherboard 600, a CPU 601, a front side bus 602, a north bridge chip 603, a main memory bus 604, a main system memory 605, a south bridge chip 606, an input/output (I/O) bus 607, a network chip 608, a network transformer 610, and a network connector 609.

In the embodiment, the electronic device 700 can be a lap-top computer. In the other embodiments, the electronic device 700 can be other electronic devices with network module.

The CPU 601, the front side bus 602, the north bridge chip 603, the main memory bus 604, the main system memory 605, the south bridge chip 606, the input/output (I/O) bus 607, the network chip 608, the network transformer 610, and the network connector 609 are disposed on the motherboard 600. The north bridge chip 603 and the south bridge chip 606 may be a chipset. The network chip 608, the network transformer 610, and the network connector 609 may be a network module.

The CPU 601 is coupled with the chipset, that is to say, the CPU 601 is coupled with the north bridge chip 603 via the front side bus 602, and the north bridge chip 603 is coupled with the south bridge chip 606. The north bridge chip 603 is coupled with the main system memory 605 via the main memory bus 604. The south bridge chip 606 is coupled with the network chip 608 via the I/O bus. The network transformer 610 is separately coupled with the network chip 608 and the network connector 609.

The CPU 601 is for controlling the whole operation of the computer device. The CPU 601 is for reading, decoding, and executing the instruction in all the operations of the computer device.

The north bridge chip 603 is for controlling signal transmission between high-speed periphery devices (such as the main system memory 55) and the CPU 51.

The south bridge chip 606 is for controlling signal transmission between low-speed periphery devices (such as the PCI bus, the USB, the LAN, the ATA, the SATA, the audio controller, the keyboard controller, the real time clock controller, and the advantage power management) and the north bridge chip 603.

In the embodiment, the network chip 608 is a network chip module, and the specification of the network transformer 610 supports the 10/100M network module. The network connector 609 is a RJ45 connector, wherein the network transformer 610 has two isolation chambers to hold the coil separately for achieving the lightning protective effect.

The network transformer 610 utilizing the differential mode coupling coil sets filters the differential signal sent out by the network chip 608, and couples the differential signal to one end of the network cable. Therefore, the signal is transmitted between the network cable and the network chip 608 without physical connection, which separates the DC component of the signal, and the signal can be transmitted between different voltage devices.

As described above, the network transformer of the preferred embodiment of the invention can improve the performance of the conventional network transformer, and promote the lightning protection effect of the network transformer to protect the network device. Therefore, the periphery devices need not to be used in the network transformer so that the whole cost of the network transformer can be saved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A network transformer disposed on a printed circuit board (PCB), the network transformer comprising:
a plurality of coil sets;
a casing;
an insulating board disposed in the casing and connecting with at least two side walls of the casing to form a plurality of isolation chambers, so that each of the insulting chambers contains one of the coil sets; and
a plurality of pins provided on the casing, wherein the network transformer is disposed on the PCB via the pins.

2. The network transformer according to claim 1, wherein the network transformer is coupled between a network chip and a network connector, and the network transformer, the network chip and the network connector are disposed on the PCB.

3. The network transformer according to claim 1, wherein the casing and the insulating board are integrally formed by the injection molding process.

4. The network transformer according to claim 1, wherein the isolation chambers are filled with insulating adhesive to fix the coil sets in the isolation chambers.

5. The network transformer according to claim 1, wherein the material of the casing and the insulating board is flame-resistant diallyl phthalate molding material.

6. An electronic device, comprising:
a circuit board;
a CPU disposed on the circuit board;
a chipset coupled with the CPU and disposed on the circuit board;
a network chip coupled with the chipset and disposed on the circuit board;
a network connector disposed on the circuit board; and
a network transformer coupled between the network chip and the network connector, wherein the network transformer comprising:
a plurality of coil sets;
a casing; and
an insulating board disposed in the casing and connecting with at least two side walls of the casing to form a plurality of isolation chambers for separately containing the coil sets.

7. The electronic device according to claim 6, wherein the casing and the insulating board are integrally formed by the injection molding process.

8. The electronic device according to claim 6, wherein the isolation chambers are filled with insulating adhesive to fix the coil sets in the isolation chambers.

9. The electronic device according to claim 6, wherein the material of the casing and the insulating board is flame-resistant diallyl phthalate molding material.

10. A network module comprising:
a network chip;
a network connector; and
a network transformer separately coupled with the network chip and the network connector, the network transformer comprising:
a plurality of coil sets;
a casing; and
an insulating board disposed in the casing and connecting with at least two side walls of the casing to form a plurality of isolation chambers for separately containing the coil sets.

11. The network module according to claim 10, wherein the casing and the insulating board are integrally formed by the injection molding process.

12. The electronic device according to claim 10, wherein the isolation chambers are filled with insulating adhesive to fix the coil sets in the isolation chamber.

13. The electronic device according to claim 10, wherein the material of the casing and the insulating board is flame-resistant diallyl phthalate molding material.
